(19) United States
(12) Patent Application Publication
(10) Pub. No.: US 2014/0167524 A1
(43) Pub. Date: Jun. 19, 2014

(54) WIRELESS POWER TRANSMISSION DEVICE AND METHOD THEREOF

(71) Applicant: KABUSHIKI KAISHA TOSHIBA, Tokyo (JP)

(72) Inventors: Noriaki OODACHI, Kawasaki-shi (JP); Kenichirou OGAWA, Tokyo (JP)

(73) Assignee: KABUSHIKI KAISHA TOSHIBA, Tokyo (JP)

(21) Appl. No.: 14/177,905

(22) Filed: Feb. 11, 2014

Related U.S. Application Data
(63) Continuation of application No. PCT/JP2012/067030, filed on Jun. 27, 2012.

(30) Foreign Application Priority Data
Sep. 14, 2011 (JP) 2011-201007

(51) Int. Cl. H01F 38/14

(52) U.S. Cl. CPC H01F 38/14
USPC 307/104

(57) ABSTRACT

There is provided a wireless power transmission device including: a first resonant coil, a first magnetic body and a second resonant coil in which the first resonant coil is supplied with AC energy to generate a magnetic field, the first magnetic body varies a form of the magnetic field generated by the first resonant coil, the second resonant coil couples with the magnetic field varied by the first magnetic body to receive the AC energy, and the first magnetic body is disposed between the first resonant coil and the second resonant coil.

### CROSS REFERENCE TO RELATED APPLICATIONS

This application is a Continuation of International Application No. PCT/JP2012/067030, filed on Jun. 27, 2012, the entire contents of which is hereby incorporated by reference.

### FIELD

An embodiment relates to a wireless power transmission device and a method thereof.

### BACKGROUND

A technology for incorporating a coil used for wireless power transmission into a device is reported. According to this report, a magnetic body is disposed in the vicinity of a power transmission coil, to be specific, between the power transmission coil and a place for disposing a conductor component. When seen from the power transmission coil, a power reception coil is disposed on a different side from the magnetic body. The magnetic body is thus disposed, thereby varying a form of a line of magnetic force and reducing the line of magnetic force acting on the place for disposing the conductor component. An eddy current is thereby restrained from occurring at the place for the disposition. The occurrence of the eddy current causes a loss of energy, and hence transmission efficiency can be increased by thus restraining the occurrence of the eddy current. Namely, the energy can be efficiently transmitted to the power reception coil from the power transmission coil.

With the configuration described above, however, if the power reception coil and the power transmission coil change in their directions with the result that these coils do not face each other, though keeping an effect of restraining the occurrence of the eddy current, such a problem arises that the efficiency of the transmission to the power reception coil to the power transmission coil declines.

### BRIEF DESCRIPTION OF THE DRAWINGS

FIG. 1 is a diagram illustrating a configuration of a wireless power transmission device according to a first embodiment;

FIG. 2 is an explanatory diagram illustrating an axis of winding of a coil and how a magnetic field varies;

FIG. 3 is a diagram depicting a configuration of a wireless power transmission device according to a second embodiment;

FIG. 4 is a diagram depicting a configuration of a wireless power transmission device according to a third embodiment;

FIG. 5 is a diagram depicting a configuration of a wireless power transmission device according to a fourth embodiment;

FIG. 6 is a diagram depicting another configuration of the wireless power transmission device according to the fourth embodiment;

FIG. 7 is an explanatory diagram illustrating a relation between frequencies;

FIG. 8 is a diagram depicting an example of how the first magnetic body is disposed;

FIG. 9 is a diagram depicting another example of how the first magnetic body is disposed;

FIG. 10 is a diagram depicting still another example of how the first magnetic body is disposed;

FIG. 11 is a diagram depicting yet another example of how the first magnetic body is disposed;

FIG. 12 is a diagram depicting an example of a shape of the first magnetic body; and

FIG. 13 is a diagram depicting another example of the shape of the first magnetic body.

### DETAILED DESCRIPTION

According to an embodiment, there is provided a wireless power transmission device including: a first resonant coil, a first magnetic body and a second resonant coil.

The first resonant coil is supplied with AC energy to generate a magnetic field.

The first magnetic body varies a form of the magnetic field generated by the first resonant coil.

The second resonant coil couples with the magnetic field varied by the first magnetic body to receive the AC energy.

The first magnetic body is disposed between the first resonant coil and the second resonant coil.

Hereinafter, embodiments will be described with reference to the drawings.

### First Embodiment

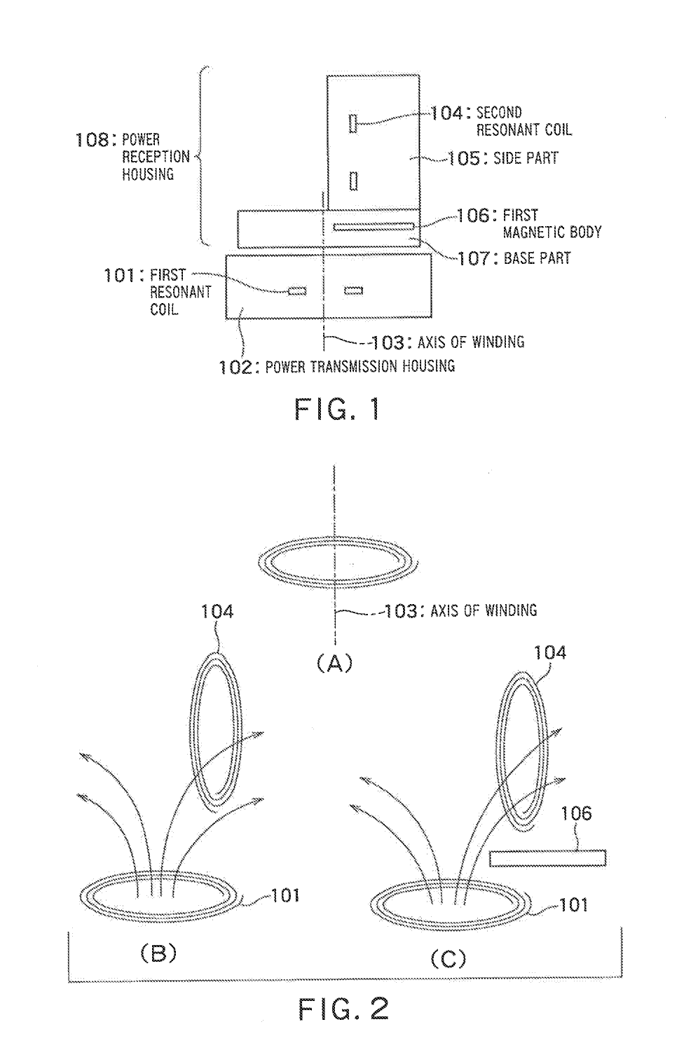

FIG. 1 illustrates a wireless power transmission device according to a first embodiment.

The wireless power transmission device includes, as large components, a power transmission housing 102 and a power reception housing 108. The power transmission housing 102 and the power reception housing 108 can be each decoupled and coupled together. There is, however, no inconvenience caused by integrating the power transmission housing 102 and the power reception housing 108 into a single unit.

The power transmission housing 102 has, as a built-in component, a first resonant coil 101 which resonates at a predetermined transmission frequency. The first resonant coil 101 receives a supply of alternating current (AC) energy, e.g., the electric power (energy) having a high frequency from an unillustrated high frequency generating circuit, and transmits a part of the AC energy to a second resonant coil 104 through magnetic coupling.

Herein, the first resonant coil 101 is configured by winding a conductor in a coil form. Herein, the conductor may be configured of a single wire or a bundle of plural wires or a litz wire built up by bundling a plurality of insulated wires.

Further, the shape of the coil may be attained by its being wound in a planar form and three-dimensionally as well. Still further, the winding mode may involve taking an arbitrary external shape such as a circle, an elliptical, a rectangle and a hexagon.

The power transmission housing 102 may have arbitrary built-in components such as electric circuits and batteries needed for the wireless power transmission other than the first resonant coil 101.

The power reception housing 108 includes a base part 107 and a side part 105 being perpendicular to the base part 107.

The side part 105 takes a shape which extends toward an axis of winding 103 of the first resonant coil 101. The coil axis of winding is, as illustrated in FIG. 2(A), an axis perpendicular to the coil face and passing through the center of the coil.

The side part 105 has a second resonant coil 104 as a built-in component.

A direction of the axis of winding of the second resonant coil 104 is different from that of the first resonant coil 101, in which these directions are perpendicular to each other. The second resonant coil 104 is configured in the same way as the first resonant coil 101 is. The second resonant coil 104 receives the AC energy through the magnetic coupling with the first resonant coil 101, and transmits the AC energy to an unillustrated device at a rear stage. A storage battery is used as the device at the rear stage, in which case the storage battery is charged with the power of the AC energy.

The base part 107 is disposed to be opposed (i.e., in a face-to-face relation) to the power transmission housing 102 and has a first magnetic body 106 as a built-in component. The first magnetic body 106 is disposed between the first resonant coil 101 and the second resonant coil 104. The first magnetic body 106 is disposed in the face-to-face relation with one of edge faces of the first resonant coil 101. The first magnetic body 106 is disposed in the face-to-face an outer surface of the second resonant coil 104. The first magnetic body 106 functions to enhance efficiency of the magnetic coupling between the first and second resonant coils. An in-depth description thereof will be made later on.

Herein, in the case of winding the coil perpendicularly to the axis, the face passing through the edge portion of the coil, perpendicular to the axis and coincident with a coil internal area embracing the coil, is referred to as an edge face of the coil.

The first magnetic body 106 is of a material having such a property that a relative permeability μr is larger than “1”. The first magnetic body 106 may be a flexible magnetic sheet and may also be a solid ferrite. An arbitrary magnetic material can be used. Herein, the first resonant coil 101 and the second resonant coil 104 resonate at a predetermined frequency. Herein, a resonant frequency is defined as a frequency calculated from an inductance L of the coil and a capacitance C of the coil in the following formula.

fr=1/2n√(LC)

Thus, the first magnetic body 106 is disposed between the first resonant coil 101 and the second resonant coil 104, thereby enabling the transmission efficiency to be increased even in such a case that the respective edge faces of the first resonant coil 101 and the second resonant coil 104 are not disposed in the face-to-face relation with each other.

To be specific, the first magnetic body 106 varies a form of a line of magnetic force generated by the first resonant coil 101. The first magnetic body 106 is disposed between the first resonant coil 101 and the second resonant coil 104 and is therefore enabled to vary the form of the line of magnetic force in the transmitting direction of the first resonant coil 101. The form of the line of magnetic force is varied, thereby making it possible to increase the number of lines of magnetic force of the first resonant coil 101 that is magnetically coupled with the second resonant coil 104, with the result that the high transmission efficiency can be kept. If the first magnetic body 106 does not exist, as depicted in FIG. 2(B), only a small quantity of lines of magnetic force coming from the first resonant coil 101 are magnetically coupled with the second resonant coil 104, resulting in a decrease in transmission efficiency. By contrast, in the case of disposing the first magnetic body 106, the form of the line of magnetic force is varied, and, as illustrated in FIG. 2(C), a larger quantity of lines of magnetic force can be magnetically coupled with the second resonant coil 104. Hence, the transmission efficiency can be increased.

Herein, the center of the first magnetic body 106 is disposed offset to the axis of winding of the first resonant coil 101. As a result, there decreases the quantity of lines of magnetic force of the first resonant coil 101, which are blocked by the first magnetic body 106, thereby enabling the wireless power to be transmitted at the high efficiency.

Namely, the lines of magnetic force are distributed about the axis of winding of the first resonant coil 101.

The center of the first magnetic body 106 is disposed offset to the axis of winding, whereby the magnetic coupling quantity of the lines of magnetic force with the first magnetic body 106 decreases. With this decrease in magnetic coupling quantity, it is feasible to reduce a loss that can occur in the first magnetic body 106.

Herein, the center of the first magnetic body 106 represents, if the magnetic body takes a square or a rectangle, an intersection of diagonal lines thereof. Alternatively, if taking an arbitrary shape, this implies a centroid of the magnetic body. Further, the term “offset” means that the axis of winding of the first resonant coil 101 does not coincide with the center of the first magnetic body 106.

As described above, according to the present embodiment, even when the first resonant coil 101 is not in the face-to-face relation with the second resonant coil 104, the first magnetic body 106 is disposed between the first resonant coil 101 and the second resonant coil 104, whereby the transmission efficiency of the wireless power transmission can be increased.

### Second Embodiment

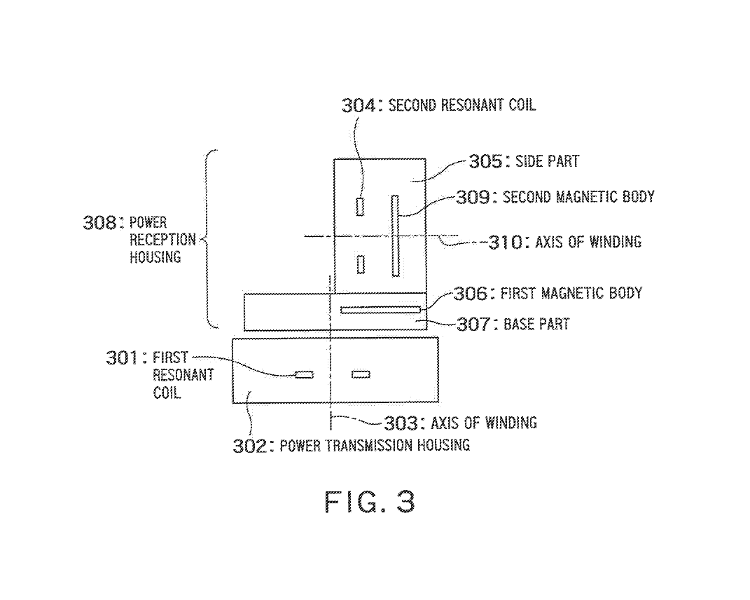

FIG. 3 depicts the wireless power transmission device according to a second embodiment.

A side part 305 has a second magnetic body 309 as a built-in component. The second magnetic body 309 is disposed in the face-to-face relation with one of edge faces of a second resonant coil 304. Namely, the second magnetic body 309 is located perpendicularly to an axis of winding 304 of the second resonant coil 304. Other components are the same as those having the same nomenclatures in the first embodiment, in which the reference numerals such as 301, 302, 303, 306, 307 and 308 are reallocated.

The second magnetic body 309 is provided for reducing the lines of magnetic force acting on the rear side of the second magnetic body 309 as viewed from the second resonant coil 304. Another component can be built in the portion with the lines of magnetic force being reduced, i.e., on the side opposite to the second resonant coil 304 of the second magnetic body 309. For example, the component such as an electronic circuit, a battery and a display can be disposed. Namely, an eddy current is restrained from being generated by reducing the lines of magnetic force acting on another component, thereby enabling the deteriorated transmission efficiency to be improved.

As discussed above, according to the second embodiment, the second magnetic body 309 is located in a way that faces the second resonant coil 304, and hence, even when another component is disposed on the rear side of the second magnetic body 309 as viewed from the second resonant coil 304, the high transmission efficiency can be kept.

### Third Embodiment

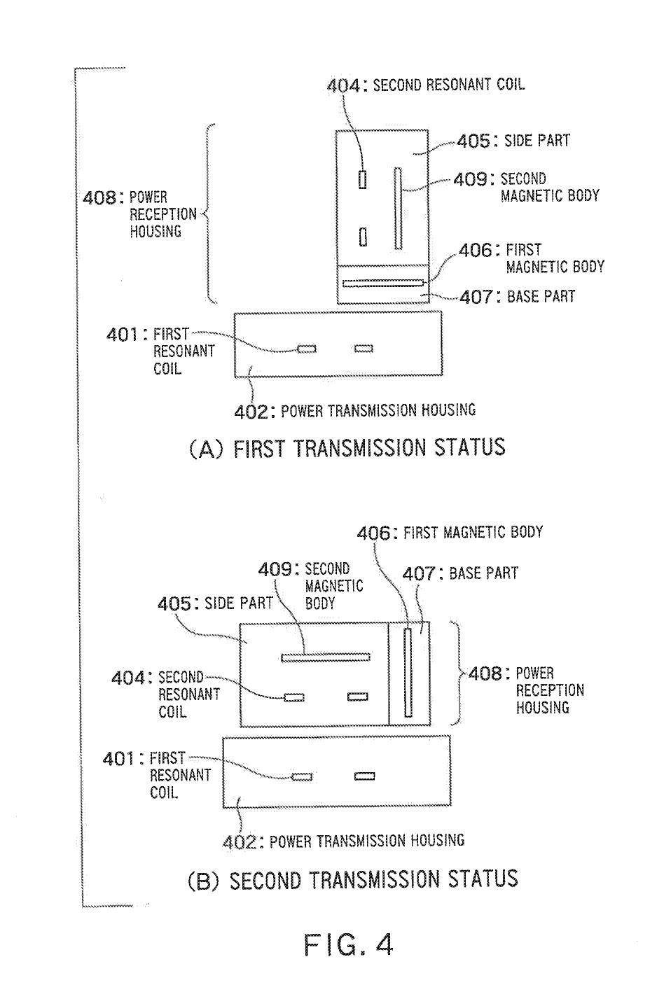

FIG. 4 illustrates the wireless power transmission device according to a third embodiment. The wireless power transmission device has a first transmission status depicted in FIG. 4(A) and a second transmission status depicted in FIG. 4(B) according to a position where a power reception housing 408 is located with respect to a power transmission housing 402.

In the first transmission status depicted in FIG. 4(A), the power reception housing 408 is located so that a first magnetic body 406 within a base part 407 is disposed in the face-to-face relation with one edge face of the first resonant coil 401.

In the second transmission status depicted in FIG. 4(B), the power reception housing 408 is located so that a second magnetic body 409 within a side part 405 is disposed in the face-to-face relation with one edge face of the first resonant coil 401 with the second resonant coil 404 being interposed therebetween.

According to the third embodiment, even when the power reception housing 408 is located in both of the positions in FIGS. 4(A) and 4(B), the high transmission efficiency can be kept concurrently.

The magnetic body is, as its effect, effective in varying the form of the line of magnetic force as already described. On the other hand, another effect is that the resonance frequency of the coil is changed. To be specific, the magnetic body has an effect of increasing an inductance L of the coil. When the inductance of one of the two coils rises, the resonance frequency of one coil varies, and a deviation of the resonance frequency occurs between one coil and the other coil, resulting in a problem of causing the deterioration of the transmission efficiency. Such being the case, the third embodiment is characterized in that the high transmission efficiency is obtained in both of the layouts in FIGS. 4(A) and 4(B) by minimizing the variation of the resonance frequency of the first resonant coil between these layouts.

The first magnetic body 406 facing the first resonant coil 401 functions so as to increase the inductance L of the first resonant coil 401 in FIG. 4(A), while a second magnetic body 409 facing the first resonant coil 401 functions likewise in FIG. 4(B). That is, in the first transmission status and the second transmission status as well, the magnetic body exists in the way of being disposed in the face-to-face relation with the first resonant coil 401. As a result, the variation of the resonance frequency of the first resonant coil 401 can be minimized between these two transmission statuses.

As discussed above, according to the third embodiment, the first and second magnetic bodies are disposed to minimize the variation of the resonance frequency of the first resonant coil 401 between the first and second transmission statuses, and hence the high transmission efficiency can be realized concurrently in the two transmission statuses.

### Fourth Embodiment

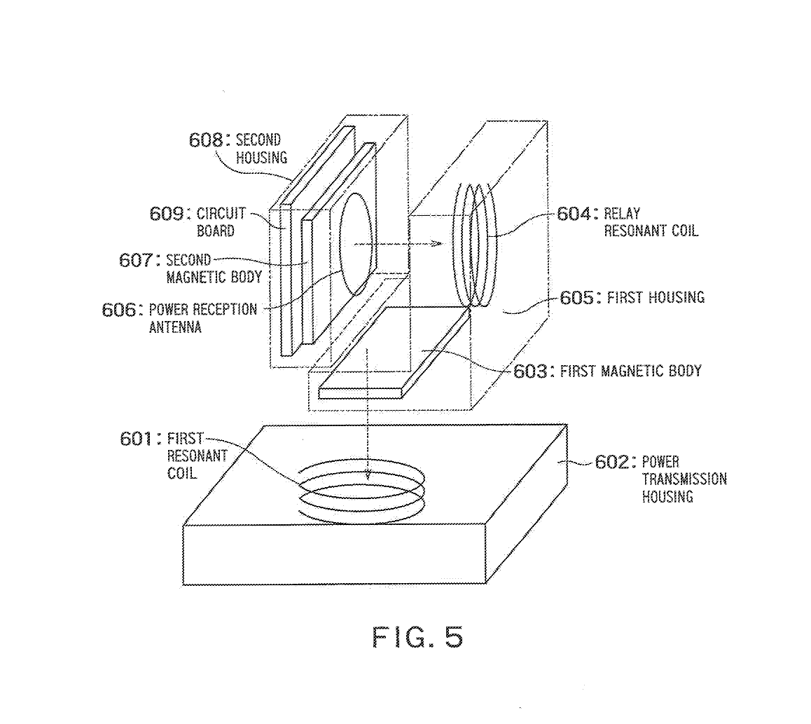

FIG. 5 illustrates the wireless power transmission device according to a fourth embodiment. The power reception housing has a configuration enabling the housing itself to be separated into a first housing 605 and a second housing 608.

The first housing 605 includes a relay resonance coil 604 and a first magnetic body 603.

The second housing 608 includes a power reception antenna 606, a second magnetic body 607 and a circuit board 609.

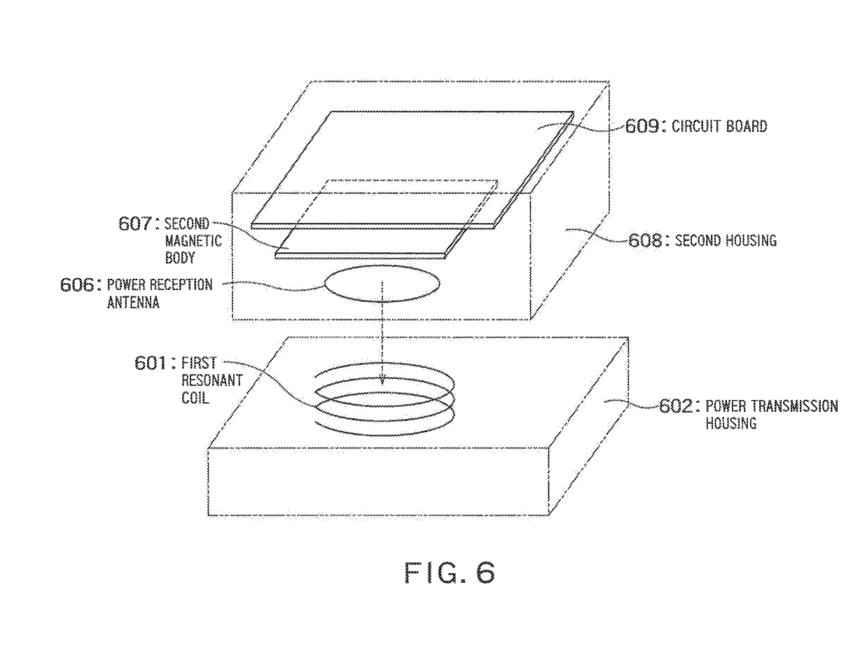

When the first housing 605 and the second housing 608 are coupled together, the power reception housing receives the power transmission from the power transmission housing 602 in this coupled status. Specifically, the power is transmitted to the power reception antenna 606 via the relay resonance coil 604 from the first resonant coil 601. Further, when separated into the first housing 605 and the second housing 608, as depicted in FIG. 6, the power transmission housing 602 performs the wireless power transmission directly to the second housing 608.

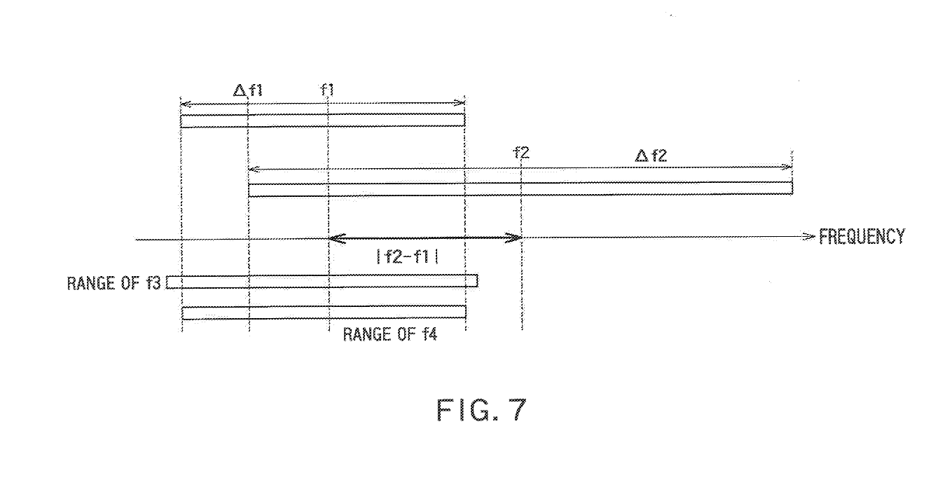

As illustrated in FIG. 7, the first resonant coil 601 has a first resonance frequency f1 and a first frequency bandwidth Δf1. The power of the AC energy having a fourth frequency f4 within a fourth frequency range is transmitted from the first resonant coil 601.

The relay resonance coil 604 has a third resonance frequency f3 and a third frequency bandwidth Δf3.

The power reception antenna 606 has a second resonance frequency f2 and a second frequency bandwidth Δf2.

The fourth frequency f4 is a frequency within the frequency bandwidth Δf1, but the fourth frequency range does not cover all the frequency range of the first resonance frequency f1 through the second resonance frequency f2.

Thus, the resonance frequency f2 of the power reception antenna 606 is set higher than the range of the power transmission frequency f4. An implication of the resonance frequency being high is that the resonance can be attained with the small inductance L and the small capacitance C. The power reception antenna 606 can be therefore downsized. Namely, the power reception antenna 606 can be constructed with a small number of windings.

As in FIG. 5, when the second housing 608 and the first housing 605 are coupled together, the power transmission is received from the power transmission housing 602 via the relay resonance coil 604 coupled with the downsized power reception antenna 606. Namely, the power transmission is performed by coupling the relay resonance coil 604 and the first resonant coil 601 together, and is further performed by coupling the relay resonance coil 604 and the power reception antenna 606 together. Through this process, it is possible to conduct the wireless power transmission from the first resonant coil 601 to the power reception antenna 606. The relay resonance coil 604 is located at the near distance from the power reception antenna 606, and therefore, even if their resonance frequencies are different from each other, the power can be transmitted between the relay resonance coil 604 and the power reception antenna 606. That is, the power transmission distance is short, in which case the high transmission efficiency can be kept even when the resonance frequency of the coil on the power transmission side is different from the resonance frequency of the coil on the power reception side.

Moreover, as depicted in FIG. 6, in the case of carrying out the wireless power transmission with the power transmission housing 602 by employing only the second housing 608, the power reception antenna 606 is located at the near distance from the first resonant coil 601, and hence the high transmission efficiency can be kept. The second housing 608 has neither the relay resonance coil nor the first magnetic body as the built-in components and can be therefore reduced both in size and in weight. If necessary function units such as an I/O interface, an electronic circuit, a battery and a memory are built in the second housing 608, only the second housing 608 can be configured portably and can be easily carried.

As described above, the fourth embodiment has the configuration which separates the power reception housing into the first housing 605 and the second housing 608 and enables the power to be received by only the second housing 608. As a result, the power reception housing can be reduced both in size and weight.

### MODIFIED EXAMPLE

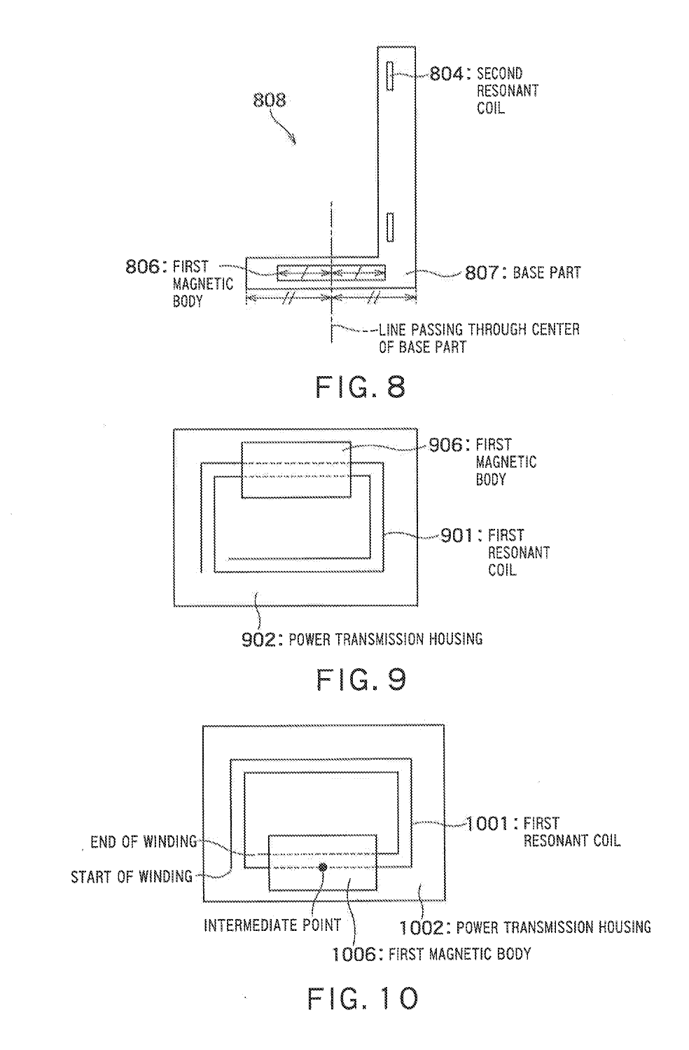

FIG. 8 depicts a first modified example.

A first magnetic body 806 is characterized by its being built in the center of a base part 807. A power reception housing 808 is disposed so that the center of the base part 807 is positioned on the central axis of the power transmission housing in many cases. The power reception housing 808 is, however, disposed in a way that deviates backward, forward, leftward and rightward from on this central axis as the case may be. In the case of deviating in this way also, it is required that the effect of the first magnetic body is enhanced.

Such being the case, as illustrated in FIG. 8, the first magnetic body 806 is built in the central portion of the base part 807. With this contrivance, even when the power reception housing 808 is disposed with the deviation from the central axis of the power transmission housing, the effect of the first magnetic body 806 can be acquired. As a result, it is feasible to attain the wireless power transmission at the high efficiency.

FIG. 9 is a plan view illustrating a second modified example. A first magnetic body 906 is disposed to be opposed to (in parallel with) the edge face of a first resonant coil 901 and in the face-to-face relation with a part of winding wire forming the edge face of the first resonant coil 901. In the case of conducting the wireless power transmission, an electric current flows to the first resonant coil 901. At this time, an effect of the first magnetic body 906 is enhanced by augmenting the coupling between this electric current and the first magnetic body 906. As the effect of the first magnetic body 906 becomes larger, the smaller magnetic body can be used. Note that the first resonant coil is wound in the planar shape in this second modified example.

Then, as in the present modified example, the first magnetic body 906 is disposed in the portion facing the winding wire of the first resonant coil 901, thereby making it possible to increase a coupling quantity between the electric current flowing to the first resonant coil 901 and the first resonant coil 901. As a consequence, the wireless power transmission device can be realized by the downsized and light-weight magnetic body.

FIG. 10 is a plan view depicting a third modified example.

A first magnetic body 1006 is disposed to be opposed to (in parallel with) the edge face of a first resonant coil 1001 in the face-to-face relation with an intermediate point between a start of winding the first resonant coil 1001 and an end thereof. A distribution of the electric current flowing to the first resonant coil 1001 has maximum current amplitude at the intermediate point between the start and the end of the winding. The first magnetic body 1006 is disposed in the face-to-face relation with this maximum current portion, whereby the effect of the magnetic body can be obtained at the maximum.

As a result, a variation quantity of the resonance frequency due to the effect of the magnetic body can be increased, and hence the first magnetic body 1006 can be reduced in area, size, weight and cost.

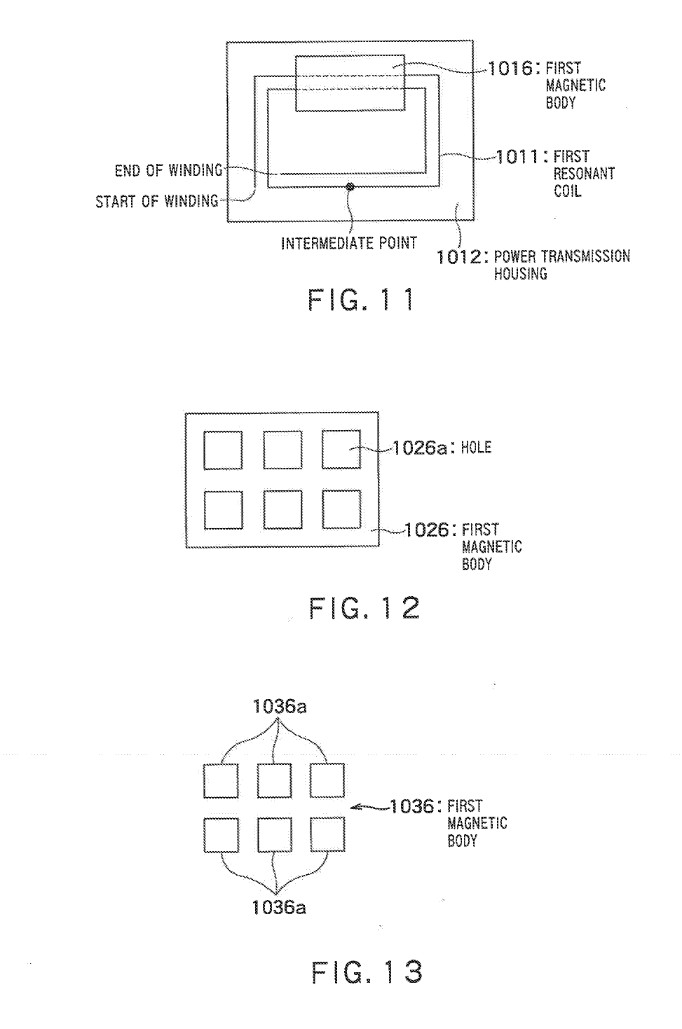

FIG. 11 is a plan view illustrating a fourth modified example.

A first magnetic body 1016 is not disposed at a portion facing an intermediate point between a start of winding a first resonant coil 1011 and an end thereof. As described above, the maximum current flows to this intermediate point. Namely, this is a portion exhibiting a large ratio to the whole wireless power transmission quantity. This being the case, the first magnetic body 1006 is disposed so as to avoid this portion, i.e., so as to face a portion different from this portion.

As a consequence, the loss due to the magnetic body is decreased, whereby the wireless power transmission at the high efficiency can be attained.

### OTHER MODIFIED EXAMPLES

The magnetic permeability of the first magnetic body may be set larger than the magnetic permeability of the second magnetic body. In this case, the area of the first magnetic body can be reduced because of the large effect of the first magnetic body.

Further, the magnetic permeability of the first magnetic body may be set the same as the magnetic permeability of the second magnetic body. In this case, the resonance frequency of the first resonant coil can be set consistent in the two transmission statuses (see FIG. 4). Still further, the use of the same magnetic body enables the types of the components to be decreased in number and leads to the reduction in cost.

Moreover, the magnetic permeability of the first magnetic body may be smaller than the magnetic permeability of the second magnetic body. In this case, the first magnetic body needs to increase in area and in thickness as well. As a result, the first magnetic body rises in weight, which gets the power reception housing hard to fall down.

Further, as depicted in FIG. 12, a first magnetic body 1026 may include one or more holes 1026a. The hole facilitates the transmission of the line of magnetic force through the first magnetic body 1026, thereby enabling the transmission efficiency to be improved.

Furthermore, as illustrated in FIG. 13, a first magnetic body 1036 may be configured to include a plurality of magnetic body pieces 1036a. This configuration facilitates the transmission of the line of magnetic force through the first magnetic body 1036, whereby the transmission efficiency can be improved.

Moreover, a metal plate may be used as a substitute for the first magnetic body. In the case of using the metal plate, a parasitic capacitance occurs between the metal plate and the first resonant coil. As a result, the resonance frequency of the first resonant coil varies. The cost can be reduced as compared with the magnetic body.

It is to be noted that in the discussion made above, though explained in the case of transmitting the power to the power reception housing from the power transmission housing, the configuration can be likewise applied to a case in which conversely the power reception housing transmits the power, while the power transmission housing receives the power.

Note that the embodiments discussed above can be utilized for applications other than the wireless power transmission. For example, wireless communications can be performed by modulating the high frequency for transmission. In this case, it may be sufficient to make use of hardware for the wireless communications as the transmission/reception hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1-16. (canceled)

17. A wireless power transmission device comprising:
a first resonant coil to be supplied with AC energy to generate a magnetic field;
a first magnetic body to vary a form of the magnetic field generated by the first resonant coil;
a second resonant coil to couple with the magnetic field varied by the first magnetic body to receive the AC energy,
a power transmission housing including the first resonant coil;
a first housing including the second resonant coil and the first magnetic body; and
a second housing including a power reception antenna and a second magnetic body disposed to be opposed to the power reception antenna,
wherein
the first housing and the second housing can be coupled with or decoupled from each other,
in a coupled status, a coupled body of the first housing and the second housing is located with respect to the power transmission housing so that the first magnetic body is disposed between the first resonant coil and the second resonant coil so as to be opposed to one of edge faces of the first resonant coil, and the power reception antenna is opposed to one of edge faces of the second resonant coil to couple with a magnetic field generated by the second resonant coil to receive the AC energy, and
in the decoupled status, the second housing is located with respect to the power transmission housing so that the second magnetic body is opposed to the one of edge faces of the first resonant coil via the power reception antenna, and the power reception antenna couples with the magnetic field generated by the first resonant coil to receive the AC energy.

18. The device according to claim 17, wherein the first magnetic body is disposed to be opposed to one of edge faces of the first resonant coil, and
the center of the first magnetic body is offset with respect to the center of the one of edge faces of the first resonant coil.

19. The device according to claim 17, further comprising:
the first housing comprises a base part including the first magnetic body and a side part being perpendicular to the base part and the side part including the second resonant coil,
wherein the first magnetic body is disposed at a center in the base part.

20. The device according to claim 17, wherein the first magnetic body is disposed to be opposed to a part of winding wire forming one of edge faces of the first resonant coil.

21. The device according to claim 17, wherein the first magnetic body is disposed to be opposed to one of edge faces of the first resonant coil and to be opposed to an intermediate point between a start of winding of the first resonant coil and an end thereof.

22. The device according to claim 17, wherein the first magnetic body is disposed to be opposed to one of edge faces of the first resonant coil and to be opposed to a different point from an intermediate point between a start of winding of he first resonant coil and an end thereof.

23. The device according to claim 17, wherein a magnetic permeability of the first resonant coil is larger than that of the second magnetic body.

24. The device according to claim 17, wherein a magnetic permeability of the first resonant coil is same as that of the second magnetic body.

25. The device according to claim 17, wherein a magnetic permeability of the first resonant coil is smaller than that of the second magnetic body.

26. The device according to claim 17, wherein the first magnetic body includes one or more holes.

27. The device according to claim 17, wherein the first magnetic body is formed of a plurality of magnetic body pieces.

28. The device according to claim 17 wherein a metal plate is used as a substitute for the first magnetic body.

29. A wireless power transmission method using a power transmission housing including a first resonant coil; a first housing including a second resonant coil and a first magnetic body; and a second housing including a power reception antenna and a second magnetic body disposed to be opposed to the power reception antenna, the first housing and the second housing being capable of being coupled with or decoupled from each other, comprising:
coupling the first housing and the second housing to each other resulting in that a coupled body of the first housing and the second housing is located with respect to the power transmission housing so that the first magnetic body is disposed between the first resonant coil and the second resonant coil so as to be opposed to one of edge faces of the first resonant coil, and the power reception antenna is opposed to one of edge faces of the second resonant coil; supplying AC energy to the first resonant coil to generate a magnetic field; varying a form of the magnetic field by means of the first magnetic body; coupling the magnetic field as varied to the second resonant coil to receive the AC energy at the second resonant; and coupling a magnetic field generated by the second resonant coli to the power reception antenna to receive the AC energy at the power reception antenna, and
locating the second housing, which is decoupled from the first housing, with respect to the power transmission housing so that the second magnetic body is opposed to the one of edge faces of the first resonant coil via the power reception antenna; supplying AC energy to the first resonant coil to generate a magnetic field; coupling a magnetic field generated by the first resonant coil to the power reception antenna to receive the AC energy at the power reception antenna.
